(19) United States
(12) Patent Application Publication
(10) Pub. No.: US 2005/0181333 A1
(43) Pub. Date: Aug. 18, 2005

(54) System and method for detecting dental caries

(76) Inventors: Naim Karazivan, Laval (CA); Emmanuel Montini, Ste-Anne-des-Lacs (CA); Francois Ayotte, Laval (CA); Mohamed Moutawakil, Montreal (CA)

Correspondence Address: GOUDREAU GAGE DUBUC, 800 PLACE VICTORIA, SUITE 3400, MONTREAL, QUEBEC, H4Z 1E9, CA

(21) Appl. No.: 10/513,043

(22) PCT Filed: May 8, 2003
(86) PCT No.: PCT/CA03/00650

(30) Foreign Application Priority Data
May 8, 2002 (CA) 2,385,981

(51) Int. Cl. A61C 5/00; A61C 3/00

(52) U.S. Cl. 433/215; 433/29

(57) ABSTRACT

A system for detecting dental caries on a tooth (T) structure comprises an electromagnetic conductor for directing at least one initial radiation (Ir) onto a tooth structure to be evaluated, an electromagnetic collector for collecting at least one resulting electromagnetic radiation (Rr) that has been at least one of reflected by and transmitted through the tooth (T) as a result of F the initial radiation (Ir). The collector is adapted to deliver the resulting electromagnetic radiation (Rr) to a detection device (D). The detection device (D) is adapted to compare at least one intensity of the at least one resulting radiation (Rr) with at least one predetermined value that corresponds to one of the presence and absence of dental caries. This enables the diagnosis of the presence or the absence of dental caries on the tooth structure.

### BACKGROUND OF THE INVENTION

1. Field of the Invention

The present relates to the detection of dental caries and, more particularly, to a system and method for detecting dental caries.

2. Description of the Prior Art

There are various known methods that are used to detect the presence of dental caries, including visual and tactile investigations using the usual dental explorer. These methods and instruments have their limits and cannot detect dental caries reliably, especially when the dental caries is proximal and when the decay is at an initial stage. X-ray investigation of teeth structure is also not reliable for detecting dental caries at the beginning of their formation in regions where a too great superimposition of enamel is present on the X-ray film. These obstructing superimpositions of teeth structures are more typical for the occlusal aspect of the teeth, and when the angle between the teeth alignment and the X-ray irradiation axis induces superimposition. The X-ray evaluation technique also exposes the patient to potentially harmful radiations.

Transillumination is another technique used to detect dental caries. By irradiating visible light toward a tooth from an aspect (e.g. lingual) and by observing via another aspect (e.g. buccal) the transmitted light, the operator can sometimes confirm the diagnosis of dental caries by observing a luminosity contrast induced by a dental caries. This technique is not suitable for all dental caries, especially for dental caries at their beginning phase. Recently, a viewing device has been developed to ease the viewing of transillumination of the teeth structure with the use of a camera.

Other devices have been devised for the detection of dental caries using luminescence or fluorescence spectroscopy with variable efficiencies depending, amongst others, on the cleanliness of the tooth surface. When irradiated with one or more initial radiations at a specific wavelength, some tooth structures generate a second radiation with a wavelength that is different from the initial radiations. The intensity and wavelength of such a second radiation is different for sound tooth structures from those for decayed tooth structures. See U.S. Pat. No. RE31,815, No. 4,479,499, No. 6,186,780, No. 6,102,704, No. 6,053,731, No. 6,135,774 and No. 5,306,144, and German Patent Publications No. DE-30 31 249-C2, No. DE-42 00 741-A1, No. DE-U1-93 17 984, No. DE-303 1249-C2 and No. DE-19541686-A1. In most cases, these devices include a laser to generate the initial exciting radiation, which can be potentially harmful to the patient.

For instance, German Patent Publication No. DE-93 17 984-U discloses a device for the detection of dental caries using a light emission unit emitting pulsed light beams and a detection unit being sensitive during a time interval delayed with respect to the emitted light pulse.

German Patent Publication No. DE-42 00 741-A1 and European Patent Publication No. EP-0 555 645-B1 describe a device for the detection of dental caries via a radiation source, working in a wavelength range from 360-500 nanometers and detecting filtered reflected radiation of wavelengths between 620 and 720 nanometers with respect to the presence or absence of dental caries.

German Patent Publication No. DE-297 04 185-U is directed to a device for the detection of caries, plaque or bacterial infections of teeth comprising an emission/detection unit which has a plurality of individual emission fibers.

German Patent Publication No. DE-197 09 500-C1 teaches a method for the detection of dental caries, plaque or bacterial infections of teeth by comparing fluorescent light levels of different portions of a tooth in order to find those parts of the tooth which are most seriously affected by the caries.

German Patent Publication No. DE-297 05 934-U discloses a device for diagnosing tooth composition using a first light source as a detection light source and a second light source as a therapeutic light source.

Electrical probes have also been developed for the detection of dental caries (U.S. Pat. No. 6,230,050) as well as ultrasonic-based detection systems.

### SUMMARY OF THE INVENTION

It is therefore an aim of the present invention to provide a novel system for the detection of dental caries.

It is also an aim of the present invention to provide a novel system for the detection of dental caries, which automatically detects the caries based on the intensity of the reflected wavelengths and/or on spectral reflectance characteristics of the caries.

It is a further aim of the present invention to provide a system in which a visual, sound-based, or other, signal is given following detection of dental caries, wherein this detection results from measurements made on the tooth and taken in one or more predetermined ranges of wavelengths that are appropriate for discriminating the spectral reflectance characteristics that constitute a signature of the presence of caries, and/or on the intensity of the reflected wavelengths.

Therefore, in accordance with the present invention, there is provided a system for detecting dental caries on a tooth structure, comprising a conductor for directing at least one initial radiation onto a tooth structure to be evaluated, a collector for collecting at least one resulting radiation that has been reflected by and/or transmitted through the tooth as a result of said initial radiation, said collector being adapted to deliver said resulting radiation to a detection device, said detection device being adapted to compare at least one intensity of said at least one resulting radiation with at least one predetermined value that corresponds to the presence or to the absence of dental caries, thereby enabling the diagnosis of the presence or absence of dental caries on the tooth structure.

Also in accordance with the present invention, there is provided a system for detecting dental caries on tooth surfaces, comprising a conductor for directing at least one initial radiation onto a tooth structure to be evaluated, a collector for collecting at least one resulting radiation that has been reflected by and/or transmitted through the tooth as a result of said initial radiation, said collector being adapted to deliver said resulting radiation to a detection device, said detection device being adapted to compare at least one wavelength of said at least one resulting radiation with at least one predetermined value that corresponds to the presence or to the absence of dental caries, thereby enabling the diagnosis of the presence or absence of dental caries on the tooth structure.

Further in accordance with the present invention, there is provided a method for detecting dental caries on a tooth structure, comprising the steps of irradiating the tooth structure with an initial radiation, collecting a reflected and/or transmitted resulting radiation, comparing the wavelength(s) and/or the intensity(ies) of radiation(s) with a predetermined value(s) that corresponds to the presence or absence of dental caries, enabling to then diagnose the presence or absence of dental caries.

Still further in accordance with the present invention, there is provided a dental caries detection system, comprising a probe adapted to be displaced along a tooth, illumination means for illuminating with an incident light a region on the tooth, detection means for collecting the resulting light reflected by and/or transmitted through the tooth, and an analyzing system for providing a signal when measurements on the resulting light in one or more predetermined ranges of wavelengths fall within any first predetermined range of values that are characteristic of dental caries, or when said measurements do not fall within any second predetermined range of values that are characteristic of artifacts other than caries.

Still further in accordance with the present invention, there is provided a dental caries detection system, comprising a probe adapted to be displaced along a tooth, illumination means for illuminating with an incident light a region on the tooth, detection means for collecting the resulting light reflected by and/or transmitted through the tooth, and an analyzing system for providing a signal when intensity measurements on the resulting light indicate one of the presence and absence of caries.

Still further in accordance with the present invention, there is provided a method for detecting dental caries in teeth, comprising the steps of: (a) providing an incident light on a region of a tooth; (b) collecting and measuring the resulting light reflected by and/or transmitted through said region of the tooth; (c) analyzing said resulting light to determine if said resulting light is representative of the presence of dental caries; and (d) providing a signal to an operator that indicates that one of presence and absence of dental caries has been detected in step (c).

### BRIEF DESCRIPTION OF THE DRAWINGS

Having thus generally described the nature of the invention, reference will now be made to the accompanying drawings, showing by way of illustration a preferred embodiment thereof, and in which:

FIGS. 1 and 4 are schematic diagrams of a system for the detection of dental caries in accordance with a first embodiment of the present invention;

FIGS. 2 and 5 are a schematic diagrams of a system for the detection of dental caries in accordance with a second embodiment of the present invention; and

FIGS. 3 and 6 are schematic diagrams of a system for the detection of dental caries in accordance with a third embodiment of the present invention.

### DESCRIPTION OF THE PREFERRED EMBODIMENTS

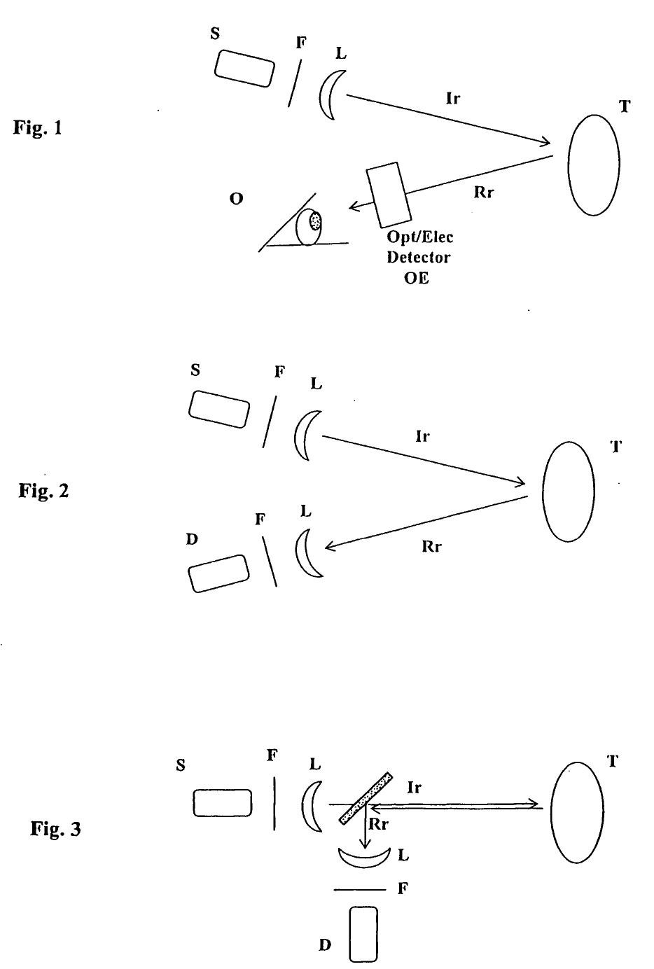

In accordance with the present invention, FIGS. 1 to 6 illustrate three systems for the automated detection of the presence of caries (tooth decay) in a patient's teeth.

Each system basically comprises three main mechanisms, that is (1) an optical hand-held tool (a buccal probe) for directing an incident light onto a tooth T and for capting light reflected by and/or light transmitted through the tooth T, (2) a device (e.g. a casing containing optical components, light sources, and acquisition and signal processing electronics) for providing a light source to the tool and for analyzing the reflected/transmitted light and providing a signal to an operator indicative of the presence of caries, and (3) a transmission device (e.g. a cable strand that includes optical fibres) that connects the hand-held tool to the analyzing device (casing). The hand-held tool mentioned hereinabove could also take the form of two distinct tools, which can be manipulated independently of one another, that is one tool for directing an incident light onto the tooth T, and another tool for capting light reflected by and/or light transmitted through the tooth T. Some further details of these components can be found in PCT Publication No. WO01/23767 (based on PCT Application No. PCT/CA01/00063).

The systems of the present invention detect the presence of caries by analyzing the intensity of the reflected/transmitted light and/or by analyzing wavelengths of the reflected/transmitted light such as to discriminate the caries present on the teeth from the healthy areas thereof, from the gums, from blood, and in fact from any artefact other than caries that the tool may encounter when it is directed towards the tooth.

The system described herein is suitable for detection of dental caries anywhere on the tooth T, and on any teeth.

The device described is for the recognition of the reflectance and/or transmittance properties of non-decayed tooth T structures and decayed tooth T structures when irradiated with visible or invisible ultra-violet (UV) or invisible infra-red (IR) wavelength(s) radiation(s).

The present invention is a dental caries detector principally based on a spectroscopic evaluation system of the reflectance and/or transmittance properties of dental structures. When a tooth structure is irradiated with an initial radiation(s) Ir, the radiation can in part be reflected on the structure surface and in part penetrate and travel inside this structure where some or all of such penetrating radiations can be deviated and/or reflected. Depending of the composition of the tooth and/or shape thereof and/or on the surrounding structures that are present, a specific structure can reflect and transmit a specific radiation differently than another structure. Depending on the origin of the irradiation and on the geographical position of the observation point of the resulting radiation(s) Rr (also called hereinafter “collected radiation”), the transmission and reflection will be different for a same structure.

In the present invention, initial electromagnetic radiation is brought to the tooth T structure, via the tool, using an electromagnetic conductor coupled with a source S. For example, an electromagnetic radiation of around 600 nm can be used alone or with an electromagnetic radiation of around 860 nm. Any other suitable radiation or group of two or more radiations in the UV, visible or IR spectrum can be used.

The source S is an electromagnetic radiation generator (for all or parts of UV-Visible-IR). Multiple sources S can be used to obtain the desired radiation(s). Filter(s) F or other optical means can be used to obtain the desired radiation(s). For example, a visible radiation (i.e. visible light) of around 600 nm wavelength can be combined with an infrared radiation of around 860 nm wavelength.

An example of sources S that can be used are: LEDs, laser-diodes, lasers, halogens light, neon light, or any other suitable type of radiation emitting source.

The wavelength of the initial electromagnetic radiation Ir, which is generated by the source S, is selected based upon the difference between the intensities of the collected radiation Rr at the same wavelength on sound tooth surfaces and on decayed tooth surfaces. The spectral band(s) and the intensity(ies) of the radiation(s) to be generated by the source(s) S is (are) selected based on the characteristic that (those) radiation(s), when it (they) encounters directly or indirectly a dental caries, has a different behaviour than when it (they) encounters a sound tooth structure or a non-dental caries structure found around or in the teeth. The wavelength(s) and the intensity(ies) is (are) selected when the more unambiguous distinction, with a determined configuration of the invention (collector, conductor, detection means, etc.), can be made between dental caries and non-dental caries tooth structures.

Three regions of the spectral band have been identified to have unambiguous discriminative potential between decay and natural tooth structures, that is two areas between 550 nm et 650 nm: around 600 nm and around 640 nm, and one area under 550 nm: around 480 nm. To discriminate between caries and other dental substances (e.g. plaque and tartar), the same technique as below can be used, but with other wavelengths (typically in the red and/or IR).

It has also been determined that, when the tooth is irradiated with light from the overall electromagnetic spectrum, a greater amount of electromagnetic radiations is reflected by dental caries than by healthy tooth structures. A system can be made using this discriminative aspect by using any electromagnetic wavelengths.

A reference wavelength over 650 nm can be used where the reflectance is similar in dental caries and in healthy tooth structures, e.g. 860 nm.

The intensity of the initial radiation(s) Ir is equal to the source S intensity less the lost in the conductor. The conductor brings the radiation from the source S to the tooth structure to be evaluated.

A feedback system can be implemented to measure the initial radiation.

The conductor can be an optical fibre or a bundle of optical fibres or any other material suitable for radiation transmission. For example, the conductor CN can be made with lens(es) and/or mirror(s).

Lenses L, mirrors or other suitable optical means, can be inserted between the source S and the conductor to enhance the coupling of the radiation into the conductor.

The initial radiation(s) Ir can be modulated and synchronized with the detector to ease the recognition of the reflected/transmitted resulting radiation(s) Rr from this initial radiation(s) Ir from 5 other radiation(s) resulting from another initial radiation(s) Ir or from noises. This method is sometimes called “Lock-in system”. One advantage of the lock-in system is its sensitivity even with very weak levels of radiation.

The resulting radiation(s) Rr is collected via a collector that brings the resulting radiation(s) Rr to a detection device D. The collector can be an optical fibre or a bundle of optical fibres or any other means suitable to bring the resulting radiation(s) Rr from the tooth T to the detection device D. For example, the collector can be made with mirrors and/or lenses.

The detection device D is used to compare the resulting radiation(s) Rr to at least one or part of one of the following measurements: other resulting radiation(s) Rr (i.e. resulting from irradiation effected at other times), noise(s) included in the resulting radiation(s) Rr or the initial radiation(s) Ir directly or indirectly, punctually or with variable of time or by using a function of the (those) measurement(s) with a predetermined range of value(s) corresponding to dental caries. For example, comparing the resulting radiation(s) Rr less the noise in that resulting radiation(s) Rr to a predetermined range of values that are in relation with the initial radiation Ir, is a typical way of determining if the measurements correspond, or not, to the presence of dental caries: when using a specific Ir intensity, if Rr less noise in Rr is over a certain value that is in function of Ir, then the detection of dental caries is positive.

Another example is when an initial radiation(s) Ir with a wavelength of around 600 nm is used. The resulting radiation(s) Rr then has a lower intensity if the tooth T structure is sound. When the resulting radiation(s) Rr is higher than a certain value, which is in relation with the initial radiation(s) Ir intensity, the diagnosis of dental caries is positive.

The detection device D can be made with a semi-conductor detector (e.g. photo-diode or LCD) that converts the resulting radiation(s) Rr into a signal or a plurality of signals. This detector sends this (those) signal(s) to an electronic or electro-mechanic system EAM that analyses the signal(s) so as to determine if there is presence of dental caries, or not. A stimulus(i) Stim (e.g. sound, light, vibration, etc.), is then generated through this electronic system EAM to inform the operator of the presence of caries. A LED can be used instead of the above photo-diode. An analog converter C/A is provided upstream of the stimulus Stim in the second and third embodiments of FIGS. 3 to 6.

The detection device D can also include a semi conductor radiation detector (e.g. photo-diode) connected to a system that converts at least one or a part of one of the following measurements: other resulting radiation(s) Rr (i.e. resulting from irradiation effected at other times), noise(s) included in the resulting radiation(s) Rr or the initial radiation(s) Ir directly or indirectly, punctually or with variable of time or by using a function of the (those) measurement(s), into the corresponding stimulus(i) Stim to the operator O (e.g. variable sound intensity, variable light signal,). The operator O then makes the distinction between stimuli associated with dental caries and stimuli associated with a sound tooth T structure. For example, the detection device can be a sound generator that emits a sound intensity equivalent to the intensity of the resulting radiation. Another example can be a graphical screen display of different radiation measurements and where the operator O uses his judgment to identify when dental caries is present, or not.

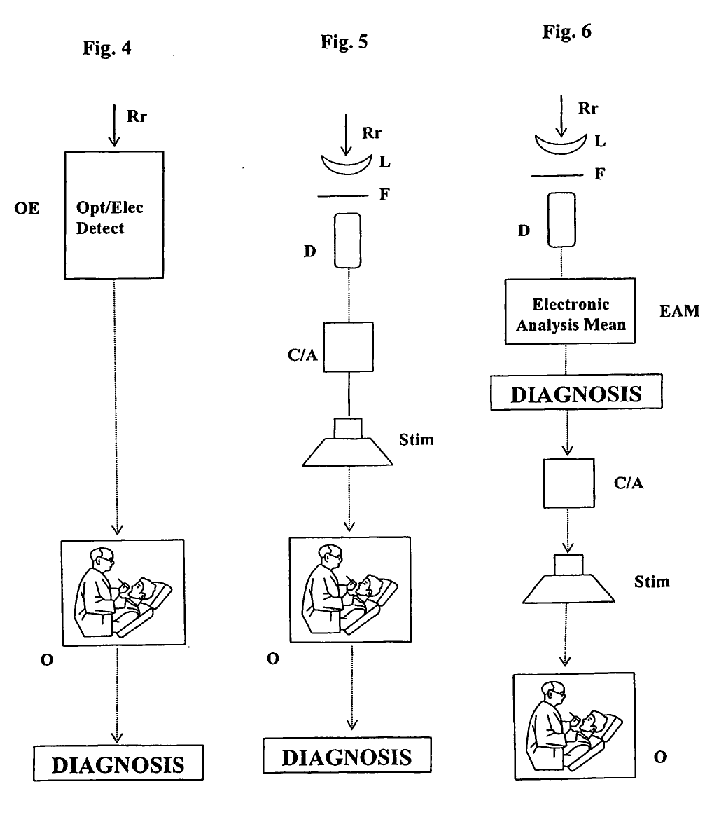

The detection device OE of FIGS. 1 and 4 can be made with physical means that convert at least one or a part of one of the following measurements on: the resulting radiation(s) Rr, noise(s) included in the resulting radiation(s) Rr or the initial radiation(s) Ir directly or indirectly, punctually or with variable of time or by using a function of the (those) measurement(s), into a corresponding stimuli to the operator O, who again then makes the distinction between stimuli associated with dental caries and stimuli associated with a sound tooth T structure. For example, this detection device OE can be a mirror that reflects the resulting radiation(s) Rr to the operator O.

For example, the electronic analysis system EAM could be made of an electronic processor and an algorithm based on independent functions of the two demodulated signals received, if the initial radiations Ir of 860 nm and 625 nm are used in conjunction with a lock-in system.

It is noted that the source S can be modulated in intensity and/or in wavelength. By modulating the current and/or the voltage of a source, the intensity and the range of wavelengths can change and the constant variation in the radiation can be used instead of multiple sources.

To enhance the detection, it may be desirable to characterize the typical response radiation on different structures in the mouth of some patients prior to beginning detection of dental caries.

The detection system, and more specifically the hand-held tool, can be partially or totally included in a device for cavities preparation (e.g. rotative handpieces, ultrasonic/sonic devices designed for preparation of teeth prior to filling, air abrasion system, etc.).

Also, The detection system can be designed to work in conjunction with an instrument to prepare the tooth and tooth region before the restoration.

The components of the present systems that will be put in contact with intra-oral tissues of the patient can be made sterilizable.

The systems of the present invention can comprise multiple conductors that can bring the initial radiation(s) from different angles or regions so as to possibly enable focalizing radiation on three dimensional regions or enable obtaining multiple readings on the same region.

A drying device can be incorporated in the systems of the invention for reducing the number of contaminants between the viewing tip of the instrument and the tooth T surface.

An intermediate substance can be inserted between the viewing end of the conductor, or the collector, and the tooth T surface to minimize undesired reflections and/or to act as a filter. For example, a transparent gel-like substance could be used.

The present systems may comprise a special marker having an affinity with dental caries and special reflectance/transmittance radiation property(ies) that can enhance or enable the detection of dental caries. For instance, a blue marker that has an affinity with dental caries will reflect radiation(s) wavelength(s) corresponding to blue.

A combined sonic or ultrasonic generator or stress generator can be implemented to induce stress or oscillation or movement in the tooth T surface enabling interferences and revealing weaker structure.

Teeth have a large morphologic variability that induces a high variability in optical response. For that reason, a comparative method can be implemented to enable the optical response to be standardized. By changing the position of the emitting point and the angle of emission, recorded values can be compared.

A liquid (e.g. water) delivery system can be incorporated to the invention to enable cleaning and/or obtaining an optical medium between the viewing end of the conductor or the collector CL and the tooth T structure.

The invention can comprise, before the collector, a perforated component that enables only radiation that is parallel to the axis of this perforated component to enter the collector. This perforated component can enable the determination of the origin of the radiation ray. For example, this perforated component can enable to determine if the radiation comes from the occlusal area or from the gingival area.

Because an occlusal dental caries is almost always found in the middle of the tooth surface, it can be interesting to compare radiation coming from that middle area to the surrounding areas. This can be done by having the collector composed of a bundle of optical fibres. This coherent bundle enables the analysis region-by-region of the coming radiation. This region-by-region analysis can be obtained by using a plurality of semi-conductor detectors or by using an opaque pattern.

The invention can comprise a mean to archive data. For example the invention can be connected to a computer that can save the data for later use, for instance to follow the evolution of caries of a given patient.

The probe end (i.e. the distal end of the tool that faces the tooth T that contains the collector and/or the conductor) may comprise graduation marks to facilitate positioning.

The systems of the present invention can also include some recalibration and/or self-testing functions. For example, if optical fibres are used, it is possible to verify if the fibres are too worn out to be efficiently used and should thus be replaced by testing the intensity of a reference light that passed through the fibres.

Also, as the spectral responses of various artifacts other than caries are known, such as those of enamel, of the tooth's root surface, of the gum, of blood, of tartar, of tooth fillings, etc., caries can be either directly detected or indirectly detected as the detection can be made to either detect caries or the absence thereof (i.e. the other presence of an artifact different than caries).

The system may be designed to focus on the tooth surface to establish if it is opaque or translucent. In the case of interproximal caries, the aim is the quantification of mineralization loss, whereas in the case of occlusal caries, the aim is the determination of the presence of caries of a size such that it requires an intervention. A bundle of optical fibres could be used to quantify the opaque surface vs. the translucent surface.

A probe end having asymmetrical fibres or emitting rays having different exit axes may constitute a way to determine a difference between translucent and opaque surfaces. There could be distinct emitting and collecting probes, where one probe is mobile and the other is fixed.

It is also contemplated to use, instead of a probe, a dental floss that contains an optical fibre as a way to bring the optical fibre to the interproximal surface. A band or strip containing a number of optical fibres could also be used when surveying the interproximal tooth surfaces, i.e. by passing the strip between the teeth.

A problem associated with the occlusal caries resides in attempts to locate the caries by trying to look through the tooth's enamel which is at an angle. To overcome this difficulty, the probe could have a gel-like tip that penetrates the grooves or wrinkles defined on the teeth thereby reducing optical effects of these wrinkles. On the interproximal level, this same tip could be used as the contacting adjacent teeth form a type of groove.

The systems of the present invention can be used during tooth repair surgical procedures, for instance to ensure that all the decay has been successfully removed.

The probe end could have a number of fibres pointing towards the same point where decay is believed to be present. At the occlusal surface, this could be useful to determine if the reflection emanates from the tooth's pulpar chamber or from a more occlusal portion.

References could be taken on a given patient's sound tooth structures to effect a calibration of the detection systems of the present invention, which is “customized” to this patient, such that measurements taken thereafter are more representative of the state of the patient's tooth structures, thereby enhancing the detection efficiency and facilitating the diagnostic.

1. A system for detecting dental caries on a tooth structure, comprising a conductor for directing at least one initial radiation onto a tooth structure to be evaluated, a collector for collecting at least one resulting radiation that has been reflected by and/or transmitted through the tooth as a result of said initial radiation, said collector being adapted to deliver said resulting radiation to a detection device, said detection device being adapted to compare at least one intensity of said at least one resulting radiation with at least one predetermined value that corresponds to the presence or to the absence of dental caries, thereby enabling the diagnosis of the presence or absence of dental caries on the tooth structure.

2. A system as defined in claim 1, wherein said detection device is also adapted to compare at least one wavelength of said at least one resulting radiation with at least one further predetermined value that corresponds to one of the presence and absence of dental caries.

3. A system as defined in claim 1, further provided with a source for providing said at least one initial radiation to said conductor.

4. A system as defined in claim 1, wherein a wavelength of said initial radiation is between 550 nm and 650 nm.

5. A system as defined in claim 4, wherein said wavelength of said initial radiation is around at least one of 600 nm and 640 nm.

6. A system as defined in claim 1, wherein a wavelength of said initial radiation is under 550 nm.

7. A system as defined in claim 6, wherein said wavelength of said initial radiation is around 480 nm.

8. A system as defined in claim 1, wherein a wavelength of said initial radiation is in the electromagnetic spectrum such that a greater amount of electromagnetic radiations is reflected by dental caries than by healthy tooth structures.

9. A system as defined in claim 4, wherein a wavelength of said initial radiation is in the infra-red so as to allow dental caries to be distinguished from plaque and tartar.

10. A system as defined in claim 6, wherein a wavelength of said initial radiation is in the infra-red so as to allow dental caries to be distinguished from plaque and tartar.

11. A system as defined in claim 1, further comprising a hand-held probe connected to said conductor and to said collector for directing said initial radiation on the tooth structure.

12. A system as defined in claim 1, further comprising a device for cavity preparation.

13. A system as defined in claim 12, wherein said device for cavity preparation includes one of a rotative handpiece, an ultrasonic/sonic device, designed for preparation of teeth prior to filling, and an air abrasion system.

14. A system as defined in claim 11, further comprising an instrument to prepare the tooth and tooth region before a restoration procedure.

15. A system as defined in claim 1, wherein said detection device is adapted to provide a signal that indicates one of the presence and absence of dental caries on the tooth structure.

16. A system as defined in claim 1, wherein said detection device is adapted to provide information that is indicative of one of the presence and absence of dental caries on the tooth structure, such that said information can be interpreted by an operator that is then able to determine the presence or absence of caries.

17. A system as defined in claim 1, wherein said conductor and said collector comprise an optical fibre contained in a dental floss for use in evaluating an interproximal tooth surface.

18. A system as defined in claim 1, wherein said conductor and said collector comprise a number of optical fibres contained in a band for use in evaluating an interproximal tooth surface.

19. A system as defined in claim 11, wherein said probe has a deformable tip adapted to conform to irregularities in tooth surfaces.

20. A system as defined in claim 19, wherein said deformable tip is made of a gel-like substance.

21. A system as defined in claim 1, further comprising separate first and second hand-held probes connected respectively to said conductor and to said collector.

22. A system as defined in claim 21, wherein one of said first and second probes is mobile during use thereof, the other remaining fixed during said use.

23. A system as defined in claim 1, wherein a data storage device is provided for keeping data on individual patients and thus allowing an evolution of a condition of the tooth structure to be followed.

24. A system as defined in claim 1, wherein a drying device is provided for reducing contaminants between a viewing tip of said conductor and the tooth surface.

25. A system as defined in claim 1, wherein an intermediate substance is provided for insertion between a viewing end of at least one of said conductor and said collector and the tooth surface to at least one of minimizing undesired reflections and acting as a filter.

26. A system as defined in claim 25, wherein said intermediate substance comprises a transparent gel-like substance.

27. A system as defined in claim 1, wherein a special marker is provided, having an affinity with dental caries and special reflectance/transmittance radiation properties for enhancing or enabling the detection of dental caries.

28. A system as defined in claim 1, wherein, upstream of said collector, a perforated member is provided for enabling only radiation that is parallel to an axis of this perforated member to access said collector.

29. A system as defined in claim 1, wherein said collector is composed of a bundle of optical fibres for enabling an analysis region-by-region of said resulting radiation.

30. A system as defined in claim 11, wherein a viewing end of said probe comprises graduation marks to facilitate positioning, said viewing end facing the tooth.

31. A system for detecting dental caries on tooth surfaces, comprising a conductor for directing at least one initial radiation onto a tooth structure to be evaluated, a collector for collecting at least one resulting radiation that has been reflected by and/or transmitted through the tooth as a result of said initial radiation, said collector being adapted to deliver said resulting radiation to a detection device, said detection device being adapted to compare at least one wavelength of said at least one resulting radiation with at least one predetermined value that corresponds to the presence or to the absence of dental caries, thereby enabling the diagnosis of the presence or absence of dental caries on the tooth structure.

32. A method for detecting dental caries on a tooth structure, comprising the steps of irradiating the tooth structure with an initial radiation, collecting a reflected and/or transmitted resulting radiation, comparing the wavelength(s) and/or the intensity(ies) of radiation(s) with a predetermined value(s) that corresponds to the presence or absence of dental caries, enabling to then diagnose the presence or absence of dental caries.

33. A method as defined in claim 32, wherein said initial radiation is selected based upon a difference between intensities of resulting radiations, at a same wavelength, on a sound tooth surface and on a decayed tooth surface.

34. A method as defined in claim 32, wherein references are taken on a given patient's sound tooth structures to effect a calibration for said given patient, such that measurements taken thereafter are more representative of the state of the given patient's tooth structures.

35. A dental caries detection system, comprising a probe adapted to be displaced along a tooth, illumination means for illuminating with an incident light a region on the tooth, detection means for collecting the resulting light reflected by and/or transmitted through the tooth, and an analyzing system for providing a signal when measurements on the resulting light in one or more predetermined ranges of wavelengths fall within any first predetermined range of values that are characteristic of dental caries, or when said measurements do not fall within any second predetermined range of values that are characteristic of artifacts other than caries.

36. A dental caries detection system, comprising a probe adapted to be displaced along a tooth, illumination means for illuminating with an incident light a region on the tooth, detection means for collecting the resulting light reflected by and/or transmitted through the tooth, and an analyzing system for providing a signal when intensity measurements on the resulting light indicate one of the presence and absence of caries.

37. A method for detecting dental caries in teeth, comprising the steps of: (a) providing an incident light on a region of a tooth; (b) collecting and measuring the resulting light reflected by and/or transmitted through said region of the tooth; (c) analyzing said resulting light to determine if said resulting light is representative of the presence of dental caries; and (d) providing a signal to an operator that indicates that one of presence and absence of dental caries has been detected in step (c).

38. A method as defined in claim 37, wherein, in step (c), the intensity of said resulting light is measured to evaluate the presence or absence of caries.
